(19) United States
(12) Patent Application Publication
(10) Pub. No.: US 2022/0042418 A1
(43) Pub. Date: Feb. 10, 2022

(54) GAS TURBINE ENGINE CERAMIC COMPONENT ASSEMBLY ATTACHMENT

(71) Applicant: Raytheon Technologies Corporation, Farmington, CT (US)

(72) Inventors: Grant O. Cook, III, Tolland, CT (US); Michael G. Abbott, Jupiter, FL (US); Michael G. McCaffrey, Windsor, CT (US)

(21) Appl. No.: 17/373,073

(22) Filed: Jul. 12, 2021

Related U.S. Application Data
(63) Continuation of application No. 14/904,560, filed on Jan. 12, 2016, now abandoned.
(60) Provisional application No. 61/847,679, filed on Jul. 18, 2013.

(51) Int. Cl. F01D 5/28; F01D 9/04

(52) U.S. Cl. CPC F01D 5/284; F01D 9/042; F01D 9/044; F05D 2300/6033; F05D 2230/23; F05D 2230/236; Y02T 50/60; F01D 5/282

(57) ABSTRACT

A gas turbine engine component assembly includes first and second portions, wherein at least one of the first and second portions is a ceramic material. The first portion includes an aperture having a first angled surface. The second portion is disposed within the aperture and includes a second angled surface adjacent to the first angled surface. The first and second angled surfaces lock the first and second portions to one another under a pulling load. A bonding material operatively secures the first and second angled surfaces to one another.

### CROSS-REFERENCE TO RELATED APPLICATIONS

This application is a Continuation of U.S. patent application Ser. No. 14/904,560 filed on Jan. 12, 2016, which is a National Phase Application of International Application No. PCT/US2014/042744 filed on Jun. 17, 2014, which claims priority to U.S. Provisional Application No. 61/847,679, which was filed on Jul. 18, 2013.

### BACKGROUND

This disclosure relates to a gas turbine engine component assembly. More particularly, the disclosure relates to a ceramic attachment used, for example, for blades or vanes that include at least one ceramic portion, such as a ceramic matrix composite, secured to another portion.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

Ceramic matrix composite (CMC) materials have been proposed for high-temperature applications, such as blades and vanes, in the turbine section as the industry pursues higher maximum temperature engine designs. Some applications subject the hardware to significant mechanical loads.

### SUMMARY

In one exemplary embodiment, a gas turbine engine component assembly includes first and second portions, wherein at least one of the first and second portions is a ceramic material. The first portion includes an aperture having a first angled surface. The second portion is disposed within the aperture and includes a second angled surface adjacent to the first angled surface. The first and second angled surfaces lock the first and second portions to one another under a pulling load. A bonding material operatively secures the first and second angled surfaces to one another.

In a further embodiment of any of the above, the gas turbine engine component assembly includes a keeper disposed between the bonding material and the first and second angled surfaces to indirectly secure the first and second portions to one another in a wedged interface.

In a further embodiment of any of the above, at least one of the first and second portions are bonded to one another using a transient liquid phase bond.

In a further embodiment of any of the above, at least one of the first and second portions are bonded to one another using a partial transient liquid phase bond.

In a further embodiment of any of the above, the first portion is constructed from a ceramic matrix composite.

In a further embodiment of any of the above, the second portion is constructed from a ceramic matrix composite.

In a further embodiment of any of the above, the keeper is constructed from a ceramic matrix composite.

In a further embodiment of any of the above, at least one of the first and second portions and the keeper is constructed from a metal alloy.

In a further embodiment of any of the above, the first portion is an airfoil and the second portion is a shroud.

In a further embodiment of any of the above, the first and second portions are constructed from a ceramic matrix composite.

In a further embodiment of any of the above, each of the first and second portions and the keeper are constructed from a ceramic matrix composite.

In a further embodiment of any of the above, the first portion extends in a longitudinal direction. The first and second angled surfaces are canted in the same direction with respect to the longitudinal direction.

In a further embodiment of any of the above, the longitudinal direction corresponds to a direction of the pulling load.

In a further embodiment of any of the above, the bonding material directly secures the first and second angled surfaces to one another.

In another exemplary embodiment, a gas turbine engine airfoil includes an airfoil and a shroud, wherein at least one of the airfoil and the shroud is a ceramic material. The shroud includes an aperture having a first angled surface. The airfoil is disposed within the aperture and includes a second angled surface adjacent to the first angled surface. The first and second angled surfaces lock the airfoil and the shroud to one another under a pulling load. A bonding material operatively secures the first and second angled surfaces to one another.

In a further embodiment of any of the above, the gas turbine engine airfoil includes a keeper disposed between the bonding material and the first and second angled surfaces to indirectly secure the airfoil and the shroud to one another in a wedged interface.

In a further embodiment of any of the above, the bonding material directly secures the first and second angled surfaces to one another.

In a further embodiment of any of the above, the airfoil extends in a radial direction. The first and second angled surfaces are canted in the same direction with respect to the radial direction, wherein the radial direction corresponds to a direction of the pulling load.

In a further embodiment of any of the above, at least one of the airfoil and the shroud are bonded to one another using a transient liquid phase bond.

In a further embodiment of any of the above, at least one of the airfoil and the shroud are bonded to one another using a partial transient liquid phase bond.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2 is a schematic perspective view of a gas turbine engine component assembly illustrating a ceramic attachment using a keeper.

FIG. 3 is a cross-sectional view of the gas turbine engine component shown in FIG. 2.

FIG. 4 is a schematic perspective view of an example airfoil assembly using the ceramic attachment.

FIG. 5 is a cross-sectional view of another ceramic attachment without the keeper.

### DETAILED DESCRIPTION

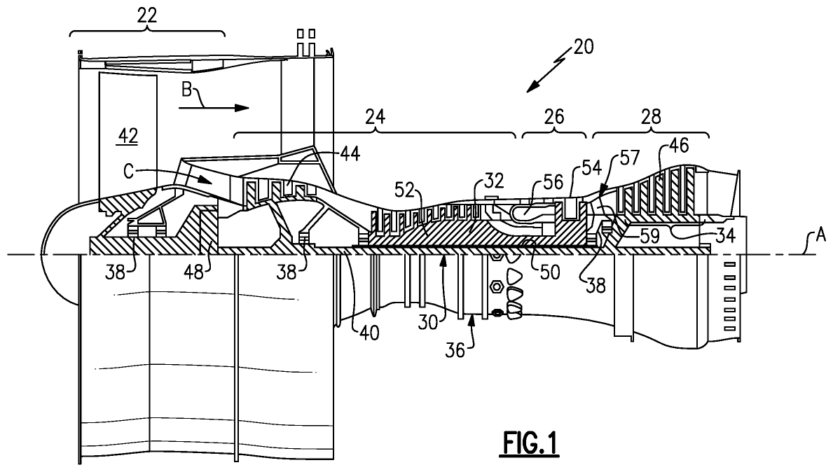

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high-pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low-pressure turbine to drive a fan via a gearbox, an intermediate spool that enables an intermediate-pressure turbine to drive a first compressor of the compressor section, and a high spool that enables a high-pressure turbine to drive a high-pressure compressor of the compressor section.

The example engine 20 generally includes a low-speed spool 30 and a high-speed spool 32 mounted for rotation about an engine central longitudinal axis X relative to an engine static structure 36 via several bearing systems 38. It should be understood that various bearing systems 38 at various locations may alternatively or additionally be provided.

The low-speed spool 30 generally includes an inner shaft 40 that connects a fan 42 and a low-pressure (or first) compressor section 44 to a low-pressure (or first) turbine section 46. The inner shaft 40 drives the fan 42 through a speed change device, such as a geared architecture 48, to drive the fan 42 at a lower speed than the low-speed spool 30. The high-speed spool 32 includes an outer shaft 50 that interconnects a high-pressure (or second) compressor section 52 and a high-pressure (or second) turbine section 54. The inner shaft 40 and the outer shaft 50 are concentric and rotate via the bearing systems 38 about the engine central longitudinal axis X.

A combustor 56 is arranged between the high-pressure compressor 52 and the high-pressure turbine 54. In one example, the high-pressure turbine 54 includes at least two stages to provide a double-stage high-pressure turbine 54. In another example, the high-pressure turbine 54 includes only a single stage. As used herein, a “high-pressure” compressor or turbine experiences a higher pressure than a corresponding “low-pressure” compressor or turbine.

The example low-pressure turbine 46 has a pressure ratio that is greater than about five (5). The pressure ratio of the example low-pressure turbine 46 is measured prior to an inlet of the low-pressure turbine 46 as related to the pressure measured at the outlet of the low-pressure turbine 46 prior to an exhaust nozzle.

A mid-turbine frame 57 of the engine static structure 36 is arranged generally between the high-pressure turbine 54 and the low-pressure turbine 46. The mid-turbine frame 57 further supports bearing systems 38 in the turbine section 28 as well as setting airflow entering the low-pressure turbine 46.

The core airflow C is compressed by the low-pressure compressor 44 then by the high-pressure compressor 52 mixed with fuel and ignited in the combustor 56 to produce high-speed exhaust gases that are then expanded through the high-pressure turbine 54 and low-pressure turbine 46. The mid-turbine frame 57 includes vanes 59, which are in the core airflow path and function as an inlet guide vane for the low-pressure turbine 46. Utilizing the vane 59 of the mid-turbine frame 57 as the inlet guide vane for low-pressure turbine 46 decreases the length of the low-pressure turbine 46 without increasing the axial length of the mid-turbine frame 57. Reducing or eliminating the number of vanes in the low-pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low-pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)—is the industry-standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry-standard temperature correction of [(Tᵣₐₘ° R)/(518.7° R)]^{0.5}. The “low corrected fan tip speed”, as disclosed herein according to one non-limiting embodiment, is less than about 1150 ft/second.

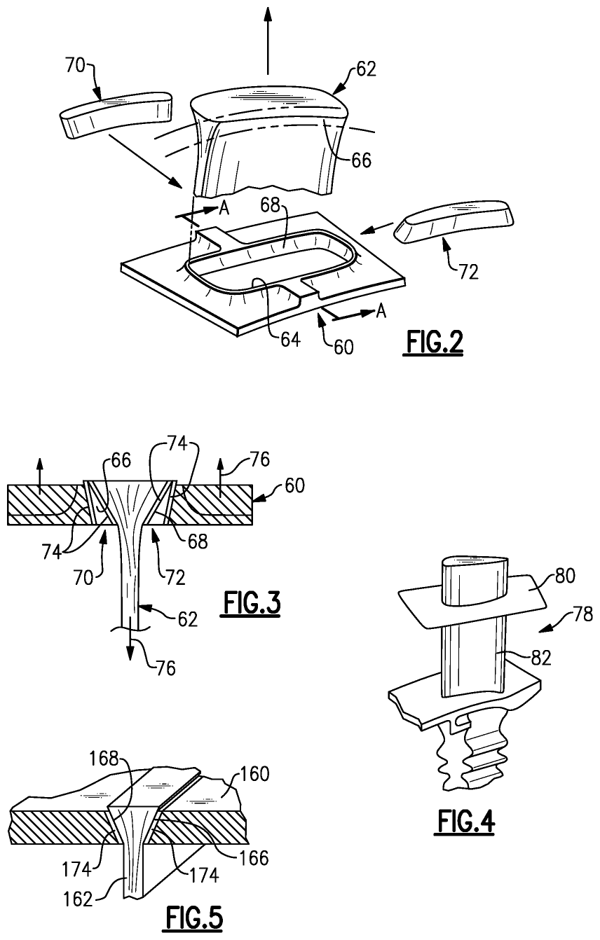

Referring to FIGS. 2 and 3, a component assembly is shown for bonding ceramic material in a manner that withstands high pulling loads, for example, from centrifugal forces. The component assembly is a gas turbine engine component, for example, a blade, vane, blade outer air seal, combustor liner, exhaust liner or other component exposed to high temperatures within a gas turbine engine.

Generally, the component assembly includes first and second portions 60, 62. At least one of the first and second portions 60, 62 is a ceramic material, such as ceramic matrix composite (CMC). The first portion 60 includes an aperture 64 having a first angled surface 66. In the example, the aperture 64 is circumscribed by continuous, unbroken structure provided by the first portion 60, such that the second portion 62 is disposed within the aperture 64 by inserting the first portion 60 through the aperture 64. The second portion 62 includes a second angled surface 68 adjacent to the first angled surface 66.

The first and second angled surfaces 66, 68 are configured to lock the first and second portions 60, 62 in a wedge-like manner under a pulling load 76. The first portion 60 extends in a longitudinal direction. The first and second angled surfaces 66, 68 are canted in the same direction with respect to the longitudinal direction, which corresponds to a direction of the pulling load 76 in the example.

In the example shown in FIG. 2, the shape of the aperture 64 and/or the profile of the second portion 62 necessitates a clearance between the first and second portions 60, 62 to facilitate assembly. In such an example, one or more keepers are used to take up the clearance and lock the first and second portions 60, 62 to one another. In the example shown, first and second keepers 70, 72 are arranged in the aperture 64 between the first and second portions 60, 62, best shown in FIG. 3.

A bond 74 operatively secures the first and second angled surfaces 66, 68 to one another to secure the assembly under shear forces. The wedge interface between the components provides additional compressive loads that further lock the components to one another, which supplements the bond in applications where the bonding material might be insufficient.

In the example shown in FIGS. 2 and 3, the first and second keepers 70, 72 are disposed between the bond 74 and the first and second angled surfaces 66, 68 to indirectly secure the first and second portions 60, 62 to one another in a wedged interface.

The bond 74 is a transient liquid phase bond and/or a partial transient liquid phase bond. One or more of the first and second portions 60, 62 and the first and second keepers 70, 72 are constructed from the ceramic matrix composite. If desired, at least one of the first and second portions 60, 62 and the first and second keepers 70, 72 are constructed from a metal alloy, such as a nickel alloy, to provide strength in applications in which a ceramic material may be inadequate.

The bonding material that produces bond 74 is a material that results in a solid bond by the process of transient liquid phase (TLP) or partial transient liquid phase (PTLP) bonding. Transient liquid phase (TLP) and partial transient liquid phase (PTLP) bonding are described in detail in “Overview of Transient Liquid Phase and Partial Transient Liquid Phase Bonding”, J. Mater. Sci. (2011) 46:5305-5323 (referred to as “the article”) and is incorporated herein by reference in its entirety. In PTLP bonding, bonding material may be a multilayer structure comprising thin layers of low-melting-point metals or alloys placed on each side of a much thicker layer of a refractory metal or alloy core. Upon heating to a bonding temperature, a liquid is formed via either direct melting of a lower-melting layer or a eutectic reaction of a lower-melting layer with the refractory metal layer. The liquid that is formed wets each ceramic substrate while also diffusing into the refractory layer. During the process, the liquid regions solidify isothermally and homogenization of the entire bond region leads to a solid refractory bond.

Example bond alloy layers (separated by pipe characters) for bonding silicon carbide to silicon carbide fiber reinforced silicon carbide (SiC/SiC) or to silicon carbide fiber reinforced silicon nitrogen carbide (SiC/SiNC) are C|Si|C, Cu—Au—Ti|Ni|Cu—Au—Ti, and Ni—Si|Mo|Ni—Si multilayer metal structures.

Example bond alloy layers for bonding silicon nitride to silicon carbide fiber reinforced silicon carbide (SiC/SiC) or silicon carbide fiber reinforced silicon nitrogen carbide (SiC/SiNC) are Al|Ti|Al, Au|Ni—Cr|Au, Cu—Au|Ni|Cu—Au, Co|Nb|Co, Co|Ta|Co, Co|Ti|Co, Co|V|Co, Cu—Ti|Pd|Cu—Ti, and Ni|V|Ni multilayer metal structures.

Additional example bond alloy layers include non-symmetric multilayer metal structures, such as Cu—Au—Ti|Ni|Cu—Au, Au|Ni—Cr|Cu—Au, Au|Ni—Cr|Cu—Au—Ti, and Al|Ti|Co. These non-symmetric structures can accommodate for differences in wetting characteristics between the ceramic material and the CMC material.

It should be understood that other bonding materials can be used according to the article and based upon the materials of the components to be bonded.

Referring to FIG. 4, the component assembly is an airfoil assembly 78. The first portion corresponds to an airfoil 82, and the second portion corresponds to a shroud 80. The shroud 80 includes the aperture having the first angled surface, and the airfoil 82 is disposed within the aperture and includes the second angled surface. The airfoil 82 and the shroud 80 are locked to one another under a pulling load, as described above in relation to FIGS. 2 and 3.

In the example shown in FIG. 5, the bonding material 174 directly secures the first and second angled surfaces 166, 168 to one another since there is no large clearance between the first and second portions 160, 162. With this configuration, the keepers may be eliminated if desired.

Although example embodiments have been disclosed, a worker of ordinary skill in this art would recognize that certain modifications would come within the scope of the claims. For that and other reasons, the following claims should be studied to determine their true scope and content.

What is claimed is:

1. A gas turbine engine component assembly comprising:
first and second portions, wherein at least one of the first and second portions is constructed from a ceramic matrix composite material, the first portion includes an aperture with a first angled surface, the second portion is disposed within the aperture and includes a second angled surface adjacent to the first angled surface, the first and second angled surfaces locking the first and second portions to one another under a pulling load; and
a bonding material is one of transient liquid phase bond layers or partial transient liquid phase bond layers, the bonding material operatively securing the first and second portions to one another.

2. The gas turbine engine component assembly according to claim 1, comprising a keeper disposed between the bonding material and the first and second angled surfaces to indirectly secure the first and second portions to one another in a wedged interface.

3. The gas turbine engine component assembly according to claim 1, wherein the first portion is constructed from the ceramic matrix composite material.

4. The gas turbine engine component assembly according to claim 1, wherein the second portion is constructed from the ceramic matrix composite material.

5. The gas turbine engine component assembly according to claim 2, wherein the keeper is constructed from the ceramic matrix composite material.

6. The gas turbine engine component assembly according to claim 2, wherein at least one of the first portion, the second portion, and/or the keeper is constructed from a metal alloy.

7. The gas turbine engine component assembly according to claim 1, wherein the second portion is an airfoil and the first portion is a shroud.

8. The gas turbine engine component assembly according to claim 2, wherein the first and second portions are constructed from the ceramic matrix composite material.

9. The gas turbine engine component assembly according to claim 8, wherein each of the first and second portions and the keeper are constructed from the ceramic matrix composite material.

10. The gas turbine engine component assembly according to claim 1, wherein the first portion extends in a longitudinal direction, the first and second angled surfaces are canted in a same direction with respect to the longitudinal direction.

11. The gas turbine engine component assembly according to claim 10, wherein the longitudinal direction corresponds to a direction of the pulling load.

12. The gas turbine engine component assembly according to claim 1, wherein the bonding material directly secures the first and second angled surfaces to one another.

13. A gas turbine engine airfoil assembly comprising:
an airfoil and a shroud, wherein at least one of the airfoil and the shroud is constructed from a ceramic matrix composite material, the shroud includes an aperture with a first angled surface, the airfoil is disposed within the aperture and includes a second angled surface adjacent to the first angled surface, the first and second angled surfaces locking the airfoil and the shroud to one another under a pulling load; and
a bonding material is one of transient liquid phase bond layers or partial transient liquid phase bond layers, the bonding material operatively securing the airfoil to the shroud.

14. The gas turbine engine airfoil assembly according to claim 13, comprising first and second keepers respectively arranged on opposing sides of the airfoil and within the aperture, one of the first and second keepers disposed between the bonding material and the first and second angled surfaces to indirectly secure the airfoil and the shroud to one another in a wedged interface, and the other of the one of the first and second keepers bonded to the airfoil and the shroud with the bonding material.

15. The gas turbine engine airfoil assembly according to claim 13, wherein the bonding material directly secures the first and second angled surfaces to one another.

16. The gas turbine engine airfoil assembly according to claim 14, wherein the airfoil extends in a radial direction, the first and second angled surfaces are canted in a same direction with respect to the radial direction, wherein the radial direction corresponds to a direction of the pulling load.
